(19) United States
(12) Patent Application Publication
(10) Pub. No.: US 2026/0178656 A1
(43) Pub. Date: Jun. 25, 2026

(54) ELECTRONIC DEVICE, METHOD, AND NON-TRANSITORY COMPUTER READABLE STORAGE MEDIUM TO GENERATE MEDIA COLLECTION INCLUDING MEDIA CONTENTS

(71) Applicant: Samsung Electronics Co., Ltd., Suwon-si (KR)

(72) Inventors: Seon HEO, Suwon-si (KR); Yoonsang KIM, Suwon-si (KR); Minh Huan LUU, Suwon-si (KR); Hojun CHA, Suwon-si (KR); Jongmoon PARK, Suwon-si (KR); Inho CHOI, Suwon-si (KR)

(21) Appl. No.: 19/312,780

(22) Filed: Aug. 28, 2025

Related U.S. Application Data
(63) Continuation of application No. PCT/KR2025/012926, filed on Aug. 25, 2025.

(30) Foreign Application Priority Data
Dec. 20, 2024 (KR) 10-2024-0193344
Jan. 9, 2025 (KR) 10-2025-0003318
Jan. 22, 2025 (KR) 10-2025-0009896

(51) Int. Cl. G06F 16/58; G06F 16/535

(52) U.S. Cl. CPC G06F 16/5866; G06F 16/535

(57) ABSTRACT

An electronic device includes memory storing instructions and at least one processor. The instructions cause the electronic device to receive a user input to generate a media collection including media contents, identify, among media contents stored in the memory, first media contents corresponding to a first keyword included in the user input, identify, based on identifying the number of the first media contents less than a reference number, among keywords assigned to the first media contents, a second keyword, identify one or more second media contents corresponding to the second keyword, and generate the media collection by using the first media contents and the one or more second media contents.

### CROSS-REFERENCE TO RELATED APPLICATION(S)

This application is a continuation application, claiming priority under 35 U.S.C. § 365(c), of an International application No. PCT/KR2025/012926, filed on Aug. 25, 2025, which is based on and claims the benefit of a Korean patent application number 10-2024-0193344, filed on Dec. 20, 2024, in the Korean Intellectual Property Office, of a Korean patent application number 10-2025-0003318, filed on Jan. 9, 2025, in the Korean Intellectual Property Office, and of a Korean patent application number 10-2025-0009896, filed on Jan. 22, 2025, in the Korean Intellectual Property Office, the disclosure of each of which is incorporated by reference herein in its entirety.

### TECHNICAL FIELD

The disclosure relates to an electronic device, a method, and a non-transitory computer-readable storage medium for generating a media collection including media contents.

### BACKGROUND ART

An electronic device may receive a user input indicating at least one of an image, a video, audio, or text. For example, the electronic device may receive the user input via a touch-sensitive display. For example, the electronic device may receive a user input indicating the audio via a camera. The electronic device may perform a function corresponding to the user input based on receiving the user input.

The above-described information may be provided as related art for the purpose of helping the understanding of the present disclosure. No claim or determination is raised as to whether any of the above-described content may be applied as prior art related to the present disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for generating a media collection including media contents.

Additional aspects will be set forth in part in the description which follows and, in part, will be apparent from the description, or may be learned by practice of the presented embodiments.

In accordance with an aspect of the disclosure, an electronic device is described. The electronic device may comprise memory comprising one or more storage media storing instructions. The electronic device may comprise at least one processor comprising processing circuitry. The instructions, when executed by the at least one processor individually or collectively, may cause the electronic device to receive a user input to generate a media collection including media contents. The instructions, when executed by the at least one processor individually or collectively, may cause the electronic device to identify, among media contents stored in the memory, first media contents corresponding to a first keyword included in the user input. The instructions, when executed by the at least one processor individually or collectively, may cause the electronic device to identify, based on identifying the number of the first media contents less than a reference number, among keywords assigned to the first media contents, a second keyword. The instructions, when executed by the at least one processor individually or collectively, may cause the electronic device to identify one or more second media contents corresponding to the second keyword. The instructions, when executed by the at least one processor individually or collectively, may cause the electronic device to generate the media collection by using the first media contents and the one or more second media contents.

In accordance with an aspect of the disclosure, a method is provided. The method may be executed in an electronic device with memory. The method may comprise receiving a user input to generate a media collection including media contents. The method may comprise identifying, among media contents stored in the memory, first media contents corresponding to a first keyword included in the user input. The method may comprise identifying, based on identifying the number of the first media contents less than a reference number, among keywords assigned to the first media contents, a second keyword. The method may comprise identifying one or more second media contents corresponding to the second keyword. The method may comprise generating the media collection by using the first media contents and the one or more second media contents.

In accordance with an aspect of the disclosure, non-transitory computer readable storage medium is provided. The non-transitory computer readable storage medium may store one or more programs. The one or more programs may comprise instructions to, when executed by an electronic device with memory, cause the electronic device to receive a user input to generate a media collection including media contents. The one or more programs may comprise instructions to, when executed by the electronic device, cause the electronic device to identify, among media contents stored in the memory, first media contents corresponding to a first keyword included in the user input. The one or more programs may comprise instructions to, when executed by the electronic device, cause the electronic device to identify, based on identifying the number of the first media contents less than a reference number, among keywords assigned to the first media contents, a second keyword. The one or more programs may comprise instructions to, when executed by the electronic device, cause the electronic device to identify one or more second media contents corresponding to the second keyword. The one or more programs may comprise instructions to, when executed by the electronic device, cause the electronic device to generate the media collection by using the first media contents and the one or more second media contents.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings.

FIG. 1 illustrates an example of an electronic device displaying a media collection according to an embodiment of the disclosure;

FIG. 2 is a simplified block diagram of an electronic device according to an embodiment of the disclosure;

FIG. 3 is a flowchart indicating an operation of an electronic device for generating a media collection including media contents according to an embodiment of the disclosure;

FIG. 4 illustrates an operation of an electronic device for identifying first media contents by using filtering information according to an embodiment of the disclosure;

FIG. 5 is a flowchart indicating an operation of an electronic device for identifying a first keyword based on a user input according to an embodiment of the disclosure;

FIG. 6A illustrates an operation of an electronic device for obtaining filtering information based on a user input according to an embodiment of the disclosure;

FIG. 6B is a flowchart indicating an operation of an electronic device for determining media contents by using an embedding vector according to an embodiment of the disclosure;

FIG. 7 is a flowchart indicating an operation of an electronic device for generating a media collection based on the number of one or more media contents according to an embodiment of the disclosure;

FIG. 8 illustrates an operation of an electronic device for generating a media collection by arranging one or more second media contents according to an embodiment of the disclosure;

FIGS. 9A to 9C illustrate an operation of an electronic device for displaying a user interface (UI) for receiving a user input according to various embodiments of the disclosure;

FIG. 10 is a block diagram of an electronic device in a network environment according to various embodiments.

FIG. 11 is a schematic diagram of an exemplary artificial intelligence (AI) system.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

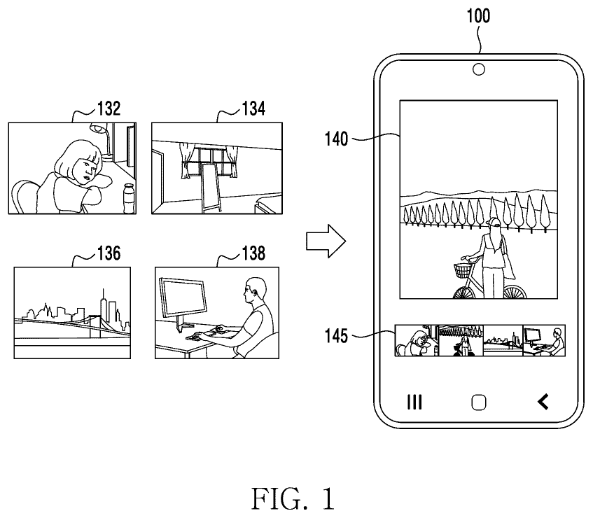

FIG. 1 illustrates an example of an electronic device displaying a media collection according to an embodiment of the disclosure.

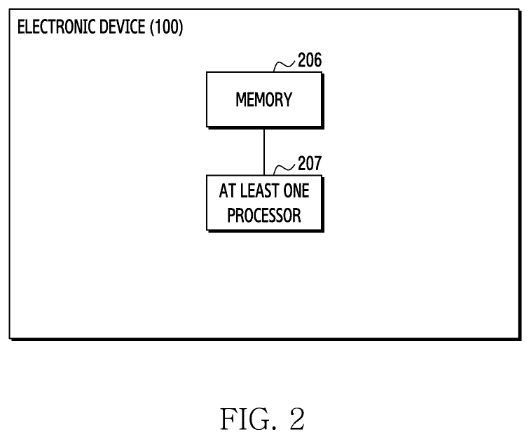

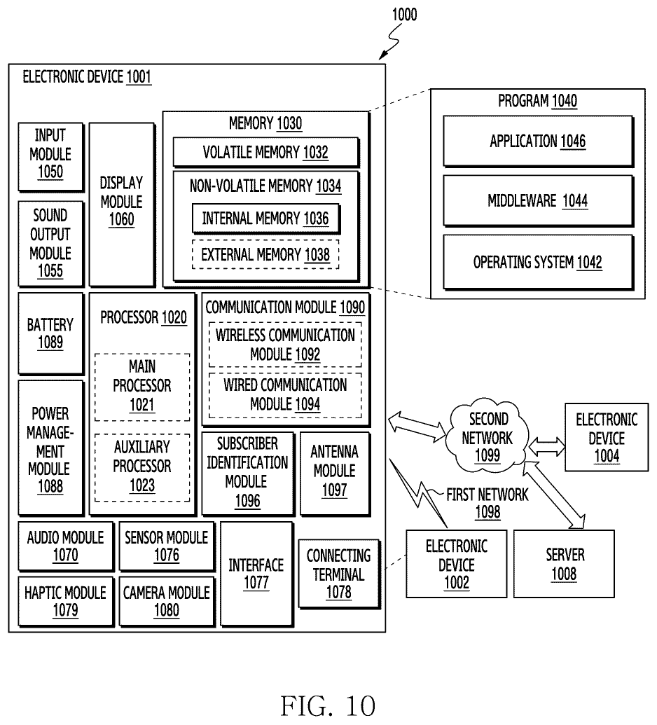

Referring to FIG. 1, an electronic device 100 may be used to generate, by using at least a portion of images 132, 134, 136, and 138, a media collection 140 that includes the at least a portion. For example, the media collection 140 may be described as a set of media contents (e.g., an image and a video) arranged in an order. For example, the media collection may include audio associated with the media contents, together with the media contents. For example, the media collection may be referred to as a story, a collection of images, a collection of videos, or a collection of media contents. For example, the electronic device 100 may generate the media collection 140 by using the images 132, 134, 136, and 138 stored in memory (e.g., memory 206 of FIG. 2) based on identifying an event for generating the media collection 140. For example, the electronic device 100 may include a display (not illustrated). For example, the electronic device 100 may display or provide the media collection 140 via the display. For example, the electronic device 100 may include a speaker (e.g., an audio module 1070 of FIG. 10). For example, when providing or playing the media collection 140, the electronic device 100 may output audio linked to (or associated with) the media collection 140 via the speaker.

According to an embodiment, when displaying the media collection 140, the electronic device 100 may display a visual object 145 to indicate the media contents included in the media collection 140 via the display. For example, the electronic device 100 may display the visual object 145 together with the media collection 140, via the display. For example, the visual object 145 may be used to indicate (or guide) a media content being displayed via the display. For example, the visual object 145 may be used to indicate (or display) a time for playing the media collection.

According to an embodiment, a user of the electronic device 100 may recall a memory by using the media collection 140 including the images 132, 134, 136, and 138. The user of the electronic device 100 may have an enjoyable time based on the media collection 140.

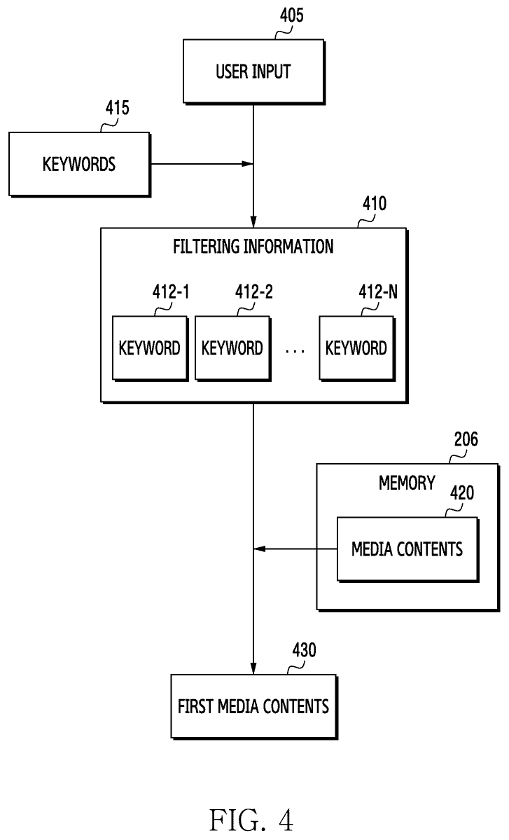

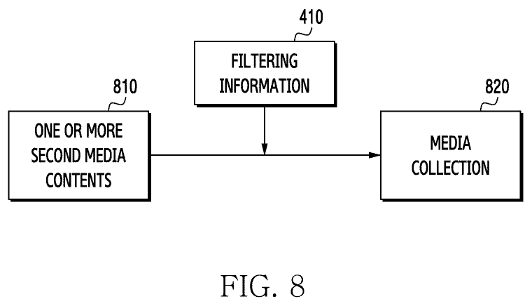

According to an embodiment, the electronic device 100 may generate the media collection 140 based on a keyword. For example, the electronic device 100 may generate the media collection 140 by using images including a specific visual object (e.g., a visual object indicating a specific person) among images stored in the memory (e.g., the memory 206 of FIG. 2). For example, the electronic device 100 may be required to generate the media collection 140 based on a user input (e.g., a user input 405 of FIG. 4). For example, the user input may indicate at least one of an image, a video, audio, or text. For example, the electronic device 100 may be required to identify media contents to be included in a media collection (e.g., a media collection 820 of FIG. 8) among media contents (e.g., media contents 420 of FIG. 4) stored in the memory (e.g., the memory 206 of FIG. 2) based on the user input. For example, the electronic device 100 may be required to identify media contents whose number is within a reference range among the media contents in the memory to generate the media collection.

For example, the electronic device 100 may identify or determine media contents to be included in the media collection (e.g., the media collection 820 of FIG. 8) among the media contents (e.g., the media contents 420 of FIG. 4) stored in the memory by using the user input. For example, the electronic device 100 may determine an order among the media contents based on the user input. For example, the electronic device 100 may generate the media collection including the media contents arranged based on the determined order.

For example, the electronic device 100 may include hardware components used to perform or execute the operations. The hardware components are described and illustrated with reference to FIG. 2.

FIG. 2 is a simplified block diagram of an electronic device according to an embodiment of the disclosure.

Referring to FIG. 2, an electronic device 100 may include at least one processor 207 and memory 206.

The at least one processor 207 may include a hardware component for processing data by using instructions stored in the memory 206. The hardware component for processing data may include a central processing unit (CPU) (e.g., including processing circuitry). The hardware component for processing data may include a graphics processing unit (GPU) (e.g., including processing circuitry). The hardware component for processing data may include a display processing unit (DPU) (e.g., including processing circuitry). The hardware component for processing data may include a neural processing unit (NPU) (e.g., including processing circuitry).

The at least one processor 207 may include one or more cores. For example, the at least one processor 207 may have a multi-core processor structure such as a dual core, a quad core, or a hexa core.

The memory 206 may include a hardware component for storing data and/or instructions inputted to and/or outputted from the at least one processor 207. The memory 206 may include, for example, volatile memory such as random-access memory (RAM), and/or non-volatile memory such as read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disc, or an embedded multimedia card (EMMC).

The at least one processor 207 may receive a user input (e.g., a user input 405 of FIG. 4) to generate a media collection (e.g., a media collection 820 of FIG. 8) including media contents. For example, the at least one processor 207 may identify first media contents (e.g., first media contents 430 of FIG. 4) corresponding to a first keyword (e.g., a keyword 412-1 of FIG. 4) included in the user input, among media contents (e.g., media contents 420 of FIG. 4) stored in the memory 206. The at least one processor 207 may identify a second keyword among keywords assigned to the first media contents, based on identifying the first media contents whose number is less than a reference number. The at least one processor 207 may identify one or more second media contents (e.g., one or more second media contents 810 of FIG. 8) corresponding to the second keyword. For example, the at least one processor 207 may generate the media collection by using the first media contents and the one or more second media contents.

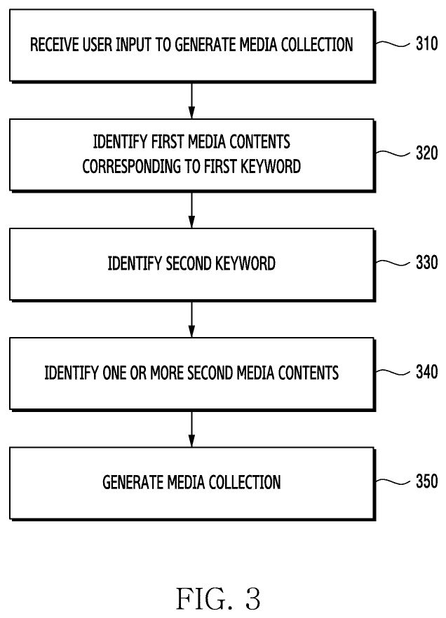

FIG. 3 is a flowchart indicating an operation of an electronic device for generating a media collection including media contents according to an embodiment of the disclosure. Such method may be executed by the electronic device 100 or the at least one processor 207 of the electronic device 100 illustrated in FIG. 2. In the following embodiment, each operation may be performed sequentially, but is not necessarily performed sequentially. For example, an order of each operation may be changed, and at least two operations may be performed in parallel.

Referring to FIG. 3, in operation 310, the at least one processor 207 may receive a user input (e.g., a user input 405 of FIG. 4) to generate a media collection (e.g., a media collection 820 of FIG. 8) including media contents. For example, the user input may include at least one of an image, a video, audio, or text. For example, the electronic device 100 may include a microphone (e.g., an input module 1050 of FIG. 10). For example, the at least one processor 207 may receive a user input indicating audio via the microphone. For example, the at least one processor 207 may include a display (e.g., a display module 1060 of FIG. 10). For example, the display may include a touch-sensitive display. For example, the at least one processor 207 may include a user input indicating text via the display. For example, the at least one processor 207 may receive a plurality of user inputs to generate the media collection. For example, a type of each of the plurality of user inputs may be different. For example, a first user input included in the plurality of user inputs may indicate text based on natural language. For example, a second user input included in the plurality of user inputs may indicate an image.

In operation 320, the at least one processor 207 may identify first media contents (e.g., first media contents 430 of FIG. 4) corresponding to a first keyword (e.g., a keyword 412-1 of FIG. 4) included in the user input (e.g., the user input 405 of FIG. 4) among media contents (e.g., media contents 420 of FIG. 4) stored in memory 206. For example, the at least one processor 207 may identify the first keyword based on the user input. For example, the first keyword may be described as a keyword, among keywords (e.g., keywords 415 of FIG. 4), corresponding to a value indicated by the user input (e.g., the user input 405 of FIG. 4). For example, identification of the first keyword will be described below with reference to FIG. 4.

In operation 330, the at least one processor 207 may identify a second keyword among the keywords 415 assigned to the first media contents 430, based on identifying the first media contents 430 whose number is less than a reference number. For example, the second keyword may be described as one of remaining keywords for keywords 412-1, 412-2, . . . , 412-N corresponding to at least one value indicating the user input 405. For example, the second keyword may be described as one of the remaining keywords for the keywords 412-1, 412-2, . . . , 412-N identified via filtering information 410 among the keywords 415. For example, the second keyword may be described as a keyword different from the first keyword associated with at least one value indicating the user input 405. For example, the at least one processor 207 may identify or determine the second keyword among the remaining keywords by using the filtering information 410. For example, the at least one processor 207 may randomly determine or identify the second keyword among the remaining keywords.

According to an embodiment, the at least one processor 207 may change a method for identifying media contents corresponding to the keyword 412-1 based on identifying the first media contents 430 whose number is greater than the reference number. For example, the at least one processor 207 may change a threshold similarity when identifying a similarity to an embedding vector, to identify media contents corresponding to the keyword 412-1 whose number is less than the reference number. For example, the at least one processor 207 may change the threshold similarity used to identify media contents to a second threshold similarity (e.g., 0.7) higher than a first threshold similarity (e.g., 0.6) used to identify the first media contents 430, based on identifying the first media contents 430 whose number is greater than the reference number. For example, the at least one processor 207 may identify second media contents whose number is less than the number of the first media content 430, among the media contents 420, based on the second threshold similarity.

According to an embodiment, the reference number may be a first reference number (e.g., 500). For example, the at least one processor 207 may identify the second keyword among the keywords 415 assigned to the first media contents 430, based on identifying the first media contents 430 whose number is less than the first reference number and greater than a second reference number (e.g., 10). For example, the at least one processor 207 may newly (or again) identify media contents corresponding to the keywords 412-1, 412-2, . . . , 412-N among the media contents 420, based on identifying the first media contents 430 whose number is less than the second reference number. For example, in order to identify media contents whose number is greater than the second reference number, the at least one processor 207 may change the threshold similarity for the identification. For example, the at least one processor 207 may change the threshold similarity for the identification from the first threshold similarity to the second threshold similarity lower than the first threshold similarity. However, it is not limited thereto. For example, the at least one processor 207 may change a method of searching (or identifying) a media content. For example, when identifying media contents corresponding to the keyword 412-1 to which a first value and a second value are assigned, the at least one processor 207 may change the method for identifying a media content from a first method for identifying a media content corresponding to the first value and the second value to a second method for identifying a media content corresponding to the first value or the second value.

In operation 340, the at least one processor 207 may identify one or more second media contents (e.g., one or more second media contents 810 of FIG. 8) corresponding to the second keyword. For example, the at least one processor 207 may identify the number of the one or more second media contents corresponding to the second keyword. For example, the at least one processor 207 may identify values for the second keyword indicated by a set of metadata corresponding to the first media contents 430. For example, the at least one processor 207 may randomly determine or identify one of the values. For example, the at least one processor 207 may determine or identify one or more media contents corresponding to the identified value as the one or more second media contents (e.g., the one or more second media contents 810 of FIG. 8).

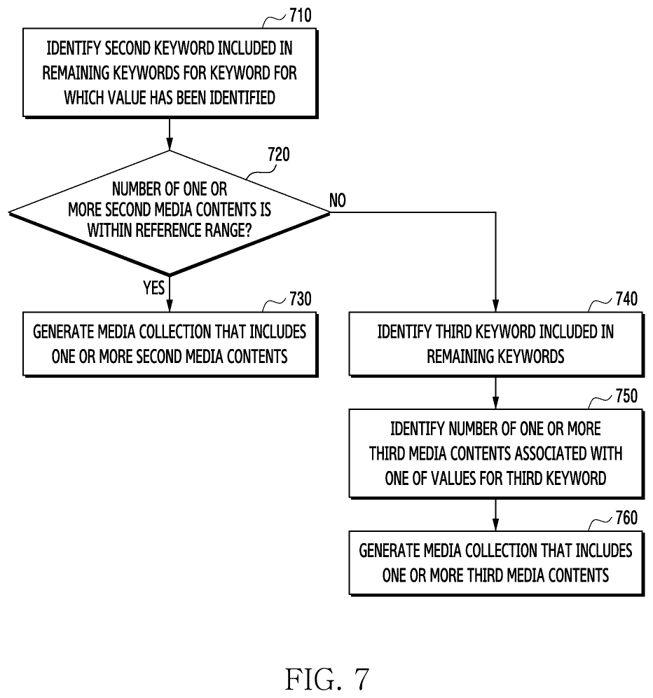

In operation 350, the at least one processor 207 may generate the media collection (e.g., the media collection 820 of FIG. 8) by using the first media contents 430 and the one or more second media contents (e.g., the one or more second media contents 810 of FIG. 8). For example, the at least one processor 207 may identify or determine a method for determining an order for media contents to be included in the media collection (e.g., the media collection 820 of FIG. 8) by using the filtering information 410 based on the user input 405. For example, the at least one processor 207 may generate the media collection (e.g., the media collection 820 of FIG. 8) including media contents arranged based on the identified order. For example, the at least one processor 207 may display the generated media collection via the display (e.g., the display module 1060 of FIG. 10). The generation of the media collection (e.g., the media collection 820 of FIG. 8) based on the second keyword will be described below with reference to FIG. 7.

FIG. 4 illustrates an operation of an electronic device for identifying first media contents by using filtering information according to an embodiment of the disclosure.

Referring to FIG. 4, at least one processor 207 may identify or obtain filtering information 410 based on a user input 405. For example, the filtering information 410 may be obtained based on a content (e.g., at least one of an image, a video, text, or audio) indicated by the user input 405, and may be described as information for searching for a media content in a database for media contents 420. For example, the filtering information 410 may indicate at least one value identified based on the user input 405, for at least a portion of keywords 415. For example, the filtering information 410 may be referred to as a story clue.

The keywords 415 may be used to indicate a media content. For example, the keywords 415 may be referred to as categories. For example, the keywords 415 may include time, a place, a person, a person relationship, a pet, an object, a background, a media type, a person description, an object description, an action, an event, a caption, a topic of a media collection, an arrangement method of media contents, and the like. For example, the media type may indicate a type of media content. For example, the type may indicate a video, an image, a spherical image (or a 360-degree image), and a spherical video (or a 360-degree video). For example, a relationship between a keyword and a value for the keyword may be described as a key-value relationship (or structure). For example, the key-value relationship may be described as a method of storing data in a key and value pair.

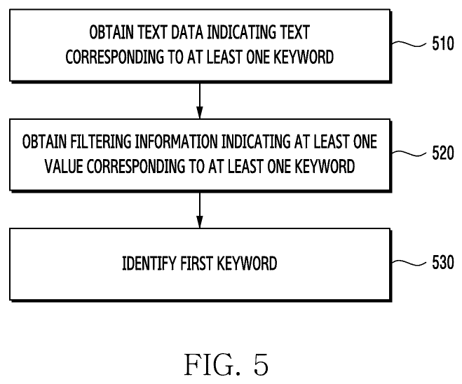

For example, the at least one processor 207 may identify or obtain values for each of the keywords 415 based on the user input 405. For example, the at least one processor 207 may identify keywords (e.g., a keyword 412-1, a keyword 412-2 to a keyword 412-N) (N is a natural number greater than or equal to 1) with identified values among the keywords 415 based on the user input 405. For example, the at least one processor 207 may obtain or identify the filtering information 410 including the keyword 412-1, the keyword 412-2 to the keyword 412-N with identified (or assigned) values based on the user input 405. For example, the at least one processor 207 may identify or determine the keyword 412-1 among the keywords with identified values, by using the filtering information 410. For example, the identification of the first keyword will be described below with reference to FIG. 5.

The at least one processor 207 may identify or determine the keyword 412-1 corresponding to a value indicating the user input 405 among the keywords 415, by using the filtering information 410 obtained based on the user input 405. For example, the at least one processor 207 may identify or determine keywords (e.g., the keyword 412-1, the keyword 412-2 to the keyword 412-N) corresponding to one or more values indicating the user input 405 among the keywords 415, by using the filtering information 410.

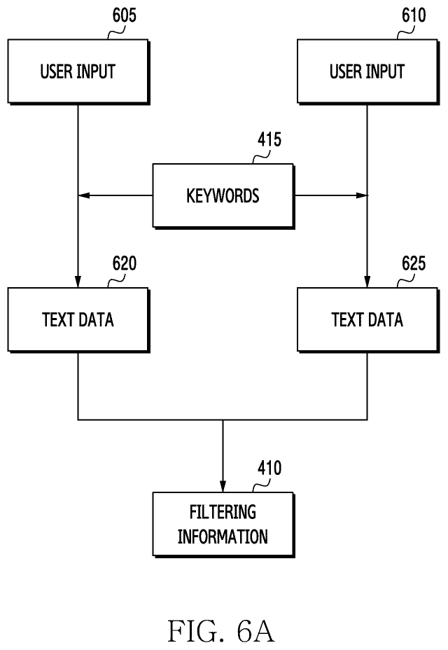

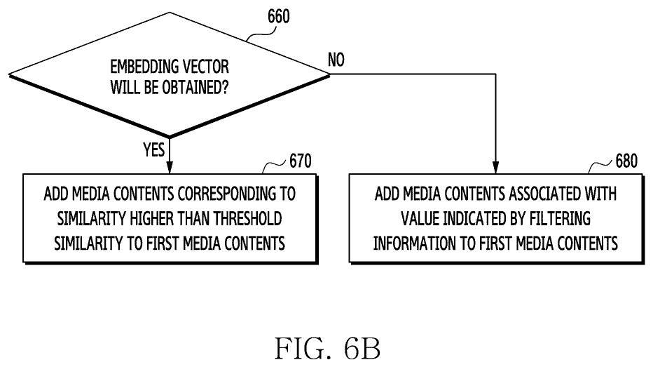

The at least one processor 207 may identify first media contents 430 corresponding to the keyword 412-1 among the media contents 420 stored in memory 206, by using the keyword 412-1. For example, the at least one processor 207 may identify the first media contents 430 among the media contents 420 by using values, identified by using the filtering information 410, indicating the user input 405. For example, the at least one processor 207 may determine, as the first media contents 430, media contents associated with the values among the media contents 420. For example, the at least one processor 207 may determine, as the first media contents 430, media contents corresponding to metadata indicating other values associated with the values. For example, the at least one processor 207 may identify metadata corresponding to the values in a set of metadata for the media contents 420 by using the values. For example, an operation of determining the first media contents 430 will be described below with reference to FIG. 6B.

FIG. 5 is a flowchart indicating an operation of an electronic device for identifying a first keyword based on a user input according to an embodiment of the disclosure. Such method may be executed by the electronic device 100 or the at least one processor 207 of the electronic device 100 illustrated in FIG. 2. In the following embodiment, each operation may be performed sequentially, but is not necessarily performed sequentially. For example, an order of each operation may be changed, and at least two operations may be performed in parallel.

Referring to FIG. 5, in operation 510, the at least one processor 207 may obtain text data (e.g., text data 620 of FIG. 6A) indicating text corresponding to at least one keyword based on a user input 405. For example, the text data (e.g., the text data 620 of FIG. 6A) may be described as data obtained by analyzing the user input 405. For example, the text data (e.g., the text data 620 of FIG. 6A) may be obtained based on the user input 405 indicating text based on natural language. For example, the text data (e.g., the text data 620 of FIG. 6A) may be described as data in which the user input 405 indicating text based on natural language is classified according to keywords 415. For example, the at least one processor 207 may obtain the text data corresponding to the user input 405 based on receiving the user input 405. For example, the text data may be referred to as a rough clue.

In operation 520, the at least one processor 207 may obtain filtering information 410 indicating at least one value corresponding to at least one keyword. For example, the at least one processor 207 may obtain or identify the filtering information 410 indicating at least one keyword in which at least one value is identified, by using the text data (e.g., the text data 620 of FIG. 6A). For example, obtaining the filtering information 410 is described and exemplified in more detail with reference to FIG. 6A.

In operation 530, the at least one processor 207 may identify a first keyword (e.g., a keyword 412-1) with an assigned value among the keywords 415, by using the filtering information 410. For example, the at least one processor 207 may identify or determine the keyword 412-1 corresponding to an identified value among the keywords 415, based on the user input 405. For example, the keyword 412-1 may be described as a keyword for which a value indicating the user input 405 has been identified (or assigned) among the keywords 415. For example, the first keyword (e.g., the keyword 412-1) may be described as a keyword (e.g., a story topic) corresponding to a value (e.g., travel) indicating the user input 405. For example, the first keyword may be described as a keyword associated with a value indicating the user input 405.

FIG. 6A illustrates an operation of an electronic device for obtaining filtering information based on a user input according to an embodiment of the disclosure.

Referring to FIG. 6A, at least one processor 207 may receive one or more user inputs to generate a media collection. For example, the at least one processor 207 may obtain text data 620 based on a user input 605. The at least one processor 207 may obtain text data 625 based on a user input 610. For example, each of the user input 605 and the user input 610 may be an example of the user input 405 of FIG. 4. For example, a type (e.g., image, video, text, or audio) of the user input 605 may be different from a type of the user input 610. However, it is not limited thereto. For example, the type of the user input 605 may be the same as the type of the user input 610.

The at least one processor 207 may obtain the text data 620 by analyzing the user input 605 for each of keywords 415. The at least one processor 207 may obtain the text data 625 by analyzing the user input 610 for each of the keywords 415. For example, text data may be referred to as a rough clue.

TABLE 1

| User Input | Test Data | |
|---|---|---|
| I want to create a story | Positive Value | Time: 2023 |
| about Sam and Kim having | | Place: Seoul |
| a meal together in Seoul | | Person: Sam and Kim |
| in 2023, but I want to | | Story Topic: Meal |
| exclude any media content | Negative Value | Place: Gangnam-gu, Seoul |
| where Park appears and | | Person: Park |
| also exclude content about | | |
| meeting in Gangnam-gu. | | |
| I want to create a story | Positive Value | Time: Last Summer |
| about my trip to Jeju | | Place: Jeju Island |
| Island with my daughter | | Relationship: Daughter |
| last summer. | | Story Topic: Travel |
| | Negative Value | |

Referring to Table 1, an example of a user input for text based on natural language and text data corresponding to the user input may be described. For example, a positive value of the text data may be used to search for or identify a media content indicating (or associated with) a value for a keyword. For example, a negative value of the text data may be used to search for or identify a content different from a media content indicating (or associated with) a value for a keyword. The at least one processor 207 may obtain filtering information 410 by combining the text data 620 and the text data 625. For example, the filtering information 410 may be described as information for searching for a media content in a database for media contents 420. For example, the at least one processor 207 may obtain the filtering information 410 by converting text indicated by text data into data for searching in the database, after combining the text data 620 and the text data 625. Although the operation of obtaining the filtering information 410 based on the combination of the text data 620 and the text data 625 has been described above, an embodiment is not limited thereto. For example, the at least one processor 207 may obtain other filtering information by combining the filtering information 410 based on a first user input and text data based on a second user input. For example, the at least one processor 207 may obtain the filtering information 410 without obtaining the text data 620 based on a type of received user input. For example, the at least one processor 207 may obtain third filtering information for identifying first media contents 430 by combining first filtering information based on the first user input and second filtering information based on the second user input.

Although the operation of obtaining the filtering information 410 based on a plurality of user inputs has been described above, an embodiment is not limited thereto. For example, the at least one processor 207 may obtain the filtering information 410 based on a single user input.

TABLE 2

| User Input | Filtering Information | |
|---|---|---|
| I want to create a story about | Positive Value | Time: 1672531200 |
| Sam and Kim having a meal | | Place: 37.5665, 126,978 |
| together in Seoul in 2023, but | | Person: Sam and Kim |
| I want to exclude any media | | Story Topic: Meal |
| content where Park appears | Negative Value | Place: 37.5172, 127.0473 |
| and also exclude content | | Person: Park |
| about meeting in Gangnam- | | |
| gu. | | |
| I want to create a story about | Positive Value | Time: 1719792000 |
| my trip to Jeju Island with my | | Place: 33.4996, 126.5312 |
| daughter last summer. | | Relationship: Daughter |
| | | Story Topic: Travel |
| | Negative Value | |

Referring to Table 2, an example of a user input for text based on natural language and filtering information corresponding to the user input may be described. For example, a positive value of the filtering information may be used to search for or identify a media content indicating (or associated with) a value for a keyword. For example, a negative value of the filtering information may be used to search for or identify a content different from a media content indicating (or associated with) a value for a keyword. For example, the negative value may be used to exclude a specific media content. The time (e.g., 2023) in Table 1 may be converted into a Unix timestamp in Table 2 for the filtering information 410. For example, the Unix timestamp may be described as a number indicating seconds that have elapsed since 0 o'clock on Jan. 1, 1970. However, it is not limited thereto. For example, in Table 2 for the filtering information 410, the time may be represented in a format of year-month-date (e.g., yyyymmdd).

The place (e.g., Seoul) in Table 1 may be converted into latitude and longitude in Table 2 for the filtering information 410. However, it is not limited thereto. For example, the place in Table 2 for the filtering information 410 may be represented as text indicating a name of a region.

According to an embodiment, the at least one processor 207 may obtain the text data 620 in which “when I went out to have fun” is assigned to a keyword for a story topic, based on receiving the user input 405 indicating “when I went out to have fun”. For example, in order to change, by using the text data 620 indicating “when I went out to have fun”, the text data 620 into a data format for searching a database, the at least one processor 207 may obtain the filtering information 410 in which “travel, outing” is assigned to the keyword for the story topic. For example, the at least one processor 207 may identify a media content indicating “travel, outing” among the media contents 420.

The text data 620 based on the user input 605 may indicate text based on natural language. For example, the text indicated by the text data 620 may correspond to at least one keyword among the keywords 415. For example, the text indicated by the text data 620 may be identified or assigned to at least one keyword among the keywords 415.

The filtering information 410 based on the text data 620 may indicate a value identified (or assigned) for at least one keyword among the keywords 415. For example, the value may indicate natural language. However, it is not limited thereto. For example, the value may indicate at least one of a number, an embedding vector, and text. For example, the value may be used to search for a media content in the database for the media contents 420. For example, the electronic device 100 may identify or determine a keyword associated with the filtering information 410 by using a database indicating a set of metadata for each of the media contents 420. For example, each metadata for each media content may indicate at least one value for at least one keyword among the keywords 415. For example, the electronic device 100 may store, in memory 206, first metadata for a first media content, together with the first media content included in the media contents 420. For example, the first metadata may indicate at least one value for at least one keyword among the keywords 415. For example, the first metadata may indicate a time (e.g., 1717200000) at which the first media content was obtained. For example, the first metadata may indicate a type of a visual object (e.g., sea, a ship, or a hamburger, and the like) included in the first media content. For example, the first metadata may indicate a type of the first media content (e.g., an image or a video).

For example, metadata for a media content may be obtained based on a plurality of trained models included in the electronic device 100. For example, when obtaining a media content, the at least one processor 207 may analyze the media content by using the plurality of trained models. For example, the at least one processor 207 may obtain or identify metadata indicating at least one value for the keywords 415 associated with the media content, based on the analysis. For example, the plurality of trained models may include a model for identifying a face in the media content, a model for identifying a background in the media content, and a model for identifying a pose in the media content. However, it is not limited thereto.

According to an embodiment, metadata for a media content may indicate a value (e.g., Christmas) assigned to a keyword (e.g., a story topic) for determining a topic of a media collection. For example, the at least one processor 207 may determine a value assigned to a keyword for determining a topic of a media collection, based on analyzing a media content via a plurality of trained models for obtaining metadata. For example, when generating a media collection, the at least one processor 207 may generate a media collection for a specific topic (e.g., Christmas) by using the value indicated by the metadata and assigned to the keyword. However, it is not limited thereto. For example, the at least one processor 207 may generate a media collection for a topic different from a topic corresponding to the value, based on the user input 405. For example, the at least one processor 207 may determine an arrangement order of media contents using the filtering information 410 based on the user input 405. For example, the determination of the arrangement order will be described below with reference to FIG. 8.

According to an embodiment, the electronic device 100 may use a trained model to obtain the text data 620 based on the user input 405. For example, the text data 620 may be obtained via a language model trained to output at least one word corresponding to at least one among the keywords 415 using text. For example, the electronic device 100 may include the trained model. For example, the trained model may include a model trained via a machine learning technique (or a deep learning technique). For example, the trained model may include a Large Language Model (LLM). For example, the trained model may include a Large Multi-modal Model (LMM). For example, the trained model may be described as a model trained to assign text to at least a portion of the keywords 415, using at least one of text, an image, a video, and audio. For example, the trained model may be described as a model trained to identify at least one word for at least one category of the keywords 415, using at least one of text, an image, a video, and audio. For example, the at least one processor 207 may obtain the text data 620 from the user input 405 via the trained model, using a designated prompt. For example, the designated prompt may be obtained via a Chain of Thought (CoT) technique or a few shot example technique. For example, the CoT technique may be described as a technique that generates an intermediate reasoning operation to solve a complex problem. For example, the few shot example technique may be described as a technique that helps a model understand a task by providing a small amount of examples when the model performs a new task.

For example, the electronic device 100 may use a Parameter-Efficient Fine-Tuning (PEFT) technique to classify words for the keywords 415 based on the user input 405. For example, the PEFT technique may be described as a technique of fine-tuning an LLM to perform a designated task. For example, the PEFT technique may include a Low-Rank Adaptation (LoRA) technique.

According to an embodiment, when receiving the user input 605 indicating text, the at least one processor 207 may divide the text indicated by the user input 605 into a plurality of parts. For example, each of the plurality of parts may be one of a word, a phrase, and a morpheme. For example, the at least one processor 207 may identify one or more parts by dividing the text based on a predetermined unit (e.g., a morpheme). For example, the at least one processor 207 may identify whether the identified one or more parts are identified in a set of metadata corresponding to the media contents 420 stored in the memory 206. For example, the at least one processor 207 may determine whether each of the identified one or more parts is identical to one of values indicated by the set of the metadata. For example, the at least one processor 207 may obtain or generate the filtering information 410 corresponding to the user input 605 indicating text without using a trained model (e.g., a language model) based on determination that all of the identified one or more parts are identified in the set of the metadata. For example, the at least one processor 207 may obtain or generate the text data 620 corresponding to the user input 605 via the trained model based on determination that at least one of the identified one or more parts is not identified in the set of the metadata. For example, when not using the trained model, the at least one processor 207 may reduce power consumed to generate a media collection (e.g., a media collection 820 of FIG. 8). For example, power consumed to generate the media collection using the trained model may be greater than power consumed to generate the media collection without using the trained model. For example, when not using the trained model, the at least one processor 207 may reduce time required to generate the media collection.

According to an embodiment, the at least one processor 207 may identify, using the user input 605 indicating text, whether a noun that requires matching is included in the text. For example, the at least one processor 207 may identify or obtain one or more parts for the text based on the user input 605. For example, each of the one or more parts may be based on one of a morpheme, a word, and a phrase. For example, the at least one processor 207 may identify whether matching information is required for each of the one or more parts. For example, the at least one processor 207 may determine to obtain the matching information based on determination that at least one of the one or more parts corresponds to a preset keyword. For example, the matching information may be described as information for matching at least one of the one or more parts with a visual object identified in a media content. For example, the at least one processor 207 may determine to obtain the matching information based on identifying that at least one of the one or more parts corresponds to a keyword for a person relationship (or a pet). For example, the at least one processor 207 may display a user interface (UI) for obtaining the matching information, via a display (not illustrated). For example, the at least one processor 207 may obtain the matching information based on receiving another user input for the UI. For example, the other user input may be described as an input for matching a visual object identified in a media content with at least one of the one or more parts.

FIG. 6B is a flowchart indicating an operation of an electronic device for determining media content by using an embedding vector according to an embodiment of the disclosure. Such method may be executed by the electronic device 100 or the at least one processor 207 of the electronic device 100 illustrated in FIG. 2.

Referring to FIG. 6B, in operation 660, the at least one processor 207 may determine whether to obtain an embedding vector using filtering information 410. For example, the at least one processor 207 may execute operation 670 based on determination to obtain an embedding vector using the filtering information 410, and may execute operation 680 based on determination not to obtain an embedding vector using the filtering information 410.

According to an embodiment, the at least one processor 207 may identify first media contents 430 among media contents 420 by using a similarity between embedding vectors. For example, the at least one processor 207 may identify similarities between embedding vectors indicating a user input 405 and corresponding to values identified by the filtering information 410, and other embedding vectors indicated by a set of metadata for the media contents 420. For example, when identifying text (or a word) corresponding to a predetermined keyword (e.g., a keyword for a person description and a keyword for an object description, and the like) via text data (e.g., text data 620 of FIG. 6A), the at least one processor 207 may calculate or obtain an embedding vector corresponding to the text. For example, the at least one processor 207 may determine to obtain a similarity for the embedding vector corresponding to the text, based on identifying the text corresponding to the predetermined keyword. For example, the similarity may be obtained via one of a Jaccard similarity technique, a cosine similarity technique, a Euclidean similarity technique, and a Manhattan similarity technique.

According to an embodiment, when identifying text (or a word) (e.g., wearing a yellow shirt) assigned to the predetermined keyword in the text data 620, the at least one processor 207 may calculate or identify an embedding vector corresponding to the text. The at least one processor 207 may represent the text as a predetermined vocabulary via a tokenizer. For example, the at least one processor 207 may calculate or identify the embedding vector corresponding to the text by performing positional encoding using an encoder.

In operation 670, the at least one processor 207 may add, based on identifying metadata corresponding to a similarity higher than a threshold similarity, a media content corresponding to the metadata to the first media contents 430. For example, the metadata may correspond to each of media contents stored in memory 206, and may indicate each of the media contents. For example, the at least one processor 207 may calculate or identify similarities between an embedding vector indicated via a value corresponding to a keyword 412-1, and other embedding vectors indicated by a set of metadata of the media contents 420. For example, the at least one processor 207 may add, based on identifying a similarity higher than the threshold similarity among the similarities, at least one media content corresponding to the similarity to the first media contents 430. For example, the at least one processor 207 may obtain a first embedding vector indicating a first value corresponding to a first keyword (e.g., the keyword 412-1), based on the user input 405 indicating an image. For example, the at least one processor 207 may obtain similarities between second embedding vectors, which respectively indicate second values (e.g., Seoul, Busan, and Jeju Island) corresponding to the first keyword (e.g., a place), respectively corresponding to the media contents 420 stored in the memory 206, and the first embedding vectors. For example, the at least one processor 207 may determine media contents corresponding to the similarity higher than the threshold similarity among the similarities as the first media contents 430.

According to an embodiment, the at least one processor 207 may change a method for identifying media contents, based on determination that the number of the first media content 430 identified using keywords 412-1, 412-2, . . . , 412-N corresponding to values indicating the user input 405 is out of a reference range (e.g., 20 to 500). For example, when a value assigned to the keyword 412-1 is a first value and a second value, the at least one processor 207 may change a method for identifying (or searching for) media contents from a first method for searching for a media content indicating the first value and the second value to a second method for searching for a media content indicating the first value or the second value. For example, using the second method, the at least one processor 207 may identify media contents among the media contents 420 using the keywords 412-1, 412-2, . . . , 412-N corresponding to a portion of the values indicating the user input 405. For example, the at least one processor 207 may generate a media collection (e.g., a media collection 820 of FIG. 8) by using the identified media contents, based on determination that the number of the identified media contents is within the reference range.

According to an embodiment, the at least one processor 207 may identify third media contents corresponding to the first value and the second value for the first keyword among the media contents 420 stored in the memory 206, based on the user input 405. For example, the at least one processor 207 may identify fourth media contents corresponding to the first value or the second value among the media contents 420 stored in the memory 206, based on identifying the number of the third media contents less than another reference number. For example, the at least one processor 207 may determine the fourth media contents as the first media contents 430, based on identifying the number of the fourth media contents less than the reference number and greater than the other reference number.

According to an embodiment, although a change in the method for searching for or identifying a media content has been described above, an embodiment is not limited thereto. For example, in a preset number of times (e.g., 10), the at least one processor 207 may identify whether the number of media contents (e.g., the first media contents 430) identified among the media contents 420 is included within the reference range. For example, when the preset number of times is 10, the at least one processor 207 may search for media contents only up to 10 times to identify media contents indicating the number within the reference range among the media contents 420. For example, the at least one processor 207 may generate a media collection (e.g., the media collection 820 of FIG. 8) using media contents indicating the number close to the reference range, based on determination that the media contents indicating the number within the reference range has not been identified or searched during the 10 searches.

In operation 680, the at least one processor 207 may add a media content associated with a value indicated by the filtering information 410 to the first media contents 430, based on determination not to obtain an embedding vector using the filtering information 410. For example, the at least one processor 207 may identify a media content corresponding to metadata associated with the value among the media contents stored in the memory 206, based on determination that the value indicated by the filtering information 410 does not correspond to the predetermined keyword (e.g., a person description and an object description). For example, the at least one processor 207 may add a media content corresponding to metadata indicating a value (substantially) identical to the value to the first media contents 430. For example, the at least one processor 207 may add a media content corresponding to metadata indicating a value within the reference range for a value indicated by the filtering information 410 to the first media contents 430.

FIG. 7 is a flowchart indicating an operation of an electronic device for generating a media collection based on the number of one or more media contents according to an embodiment of the disclosure. Such method may be executed by the electronic device 100 or at least one processor 207 of the electronic device 100 illustrated in FIG. 2. In the following embodiment, each operation may be performed sequentially, but is not necessarily performed sequentially. For example, an order of each operation may be changed, and at least two operations may be performed in parallel.

Referring to FIG. 7, in operation 710, the at least one processor 207 may identify a second keyword among remaining keywords for a keyword for which a value indicating a user input 405 has been identified. For example, the at least one processor 207 may identify or determine at least one keyword corresponding to at least one value indicating the user input 405 among keywords 415, by using filtering information 410 based on the user input 405. For example, the at least one processor 207 may determine remaining keywords for the at least one keyword corresponding to the at least one value among the keywords 415. For example, the at least one processor 207 may randomly determine the second keyword among the remaining keywords. For example, the second keyword may be described as one of the remaining keywords. For example, the remaining keywords may be described as keywords among the keywords 415 that are not the at least one keyword corresponding to the at least one value indicating the user input 405.

In operation 720, the at least one processor 207 may execute operation 730 based on determination that the number of one or more second media contents (e.g., one or more second media contents 810 of FIG. 8) associated with one of values (e.g., Seoul, Busan, Jeju Island, and the like) for the second keyword (e.g., a place) is within a reference range (e.g., 10 to 30), and may execute operation 740 based on determination that the number of the one or more second media contents 810 is not within the reference range. For example, the at least one processor 207 may identify the values for the second keyword by using a set of metadata indicating first media contents 430. For example, the values may be indicated by the set. For example, the at least one processor 207 may search for or identify media contents associated with the values among the first media contents 430 by using the set of the metadata indicating the first media contents 430.

The at least one processor 207 may randomly determine one of the values. For example, at least one processor 207 may identify the number of the one or more second media contents (e.g., the one or more second media contents 810 of FIG. 8) associated with the determined one. The at least one processor 207 may identify the number of the one or more second media contents (e.g., the one or more second media contents 810 of FIG. 8) corresponding to a value substantially identical to the determined one. For example, the at least one processor 207 may determine or identify one or more media contents corresponding to metadata indicating the substantially identical value among the first media contents 430 as the one or more second media contents 810. Although the operation of identifying the number of the one or more second media contents (e.g., the one or more second media contents 810 of FIG. 8) corresponding to the same value as the determined one has been described above, an embodiment is not limited thereto. For example, the at least one processor 207 may identify the number of the one or more second media contents (e.g., the one or more second media contents 810 of FIG. 8) corresponding to a similar value (e.g., when a similarity between embedding vectors is higher than a threshold similarity) to the determined one. For example, the at least one processor 207 may identify the number of the one or more second media contents (e.g., the one or more second media contents 810 of FIG. 8) corresponding to a value included within a reference range (e.g., [1672531200, 1704067199] represented in Unix timestamp) for the determined one (e.g., 1700000000 represented in Unix timestamp). For example, the at least one processor 207 may identify whether the number of the identified one or more second media contents (e.g., the one or more second media contents 810 of FIG. 8) is within a reference range (e.g., 30 to 100). For example, the reference range may be preset. For example, the reference range may be changed based on a user input.

In operation 730, the at least one processor 207 may generate a media collection (e.g., a media collection 820 of FIG. 8) that includes the one or more second media contents (e.g., the one or more second media contents 810 of FIG. 8). For example, the at least one processor 207 may generate the media collection including the one or more second media contents based on determination that the number of the one or more second media contents is within a reference range. For example, the at least one processor 207 may display the media collection via a display (not illustrated). For example, the generation of the media collection will be described below with reference to FIG. 8.

In operation 740, the at least one processor 207 may identify a third keyword among the remaining keywords based on determination that the number of the one or more second media contents 810 is not within the reference range. For example, the at least one processor 207 may randomly identify or determine the third keyword, different from the second keyword, among the remaining keywords for the at least one keyword for which at least one value indicating the user input 405 has been identified, based on determination that the number of the one or more second media contents 810 is out of the reference range.

In operation 750, the at least one processor 207 may identify the number of one or more third media contents associated with one of values for the third keyword. For example, the at least one processor 207 may randomly identify one of the values for the third keyword by using a set of metadata corresponding to the first media contents 430.

In operation 760, the at least one processor 207 may generate a media collection (e.g., the media collection 820 of FIG. 8) that includes the one or more third media contents, based on determination that the number of the one or more third media contents is within the reference range.

According to an embodiment, the at least one processor 207 may identify a value corresponding to a keyword for a story topic by using the filtering information 410. For example, the at least one processor 207 may identify whether a value is assigned to the keyword for the story topic, by using the filtering information 410. For example, when a value indicating the keyword for the story topic is identified via the filtering information 410, the at least one processor 207 may identify media contents corresponding to the value among the first media contents 430. For example, the at least one processor 207 may generate the media collection 820 using the identified media contents.

According to an embodiment, the at least one processor 207 may determine the value corresponding to the keyword for the story topic, based on failing to identify the value corresponding to the keyword for the story topic, using the filtering information 410. For example, the at least one processor 207 may determine the value corresponding to the keyword for the story topic as a predetermined value. For example, the at least one processor 207 may identify media contents corresponding to the predetermined value among the first media contents 430. For example, the at least one processor 207 may generate the media collection 820 by using the identified media contents. Although the operation of generating the media collection 820 by using the value of the keyword for the story topic has been described above, an embodiment is not limited thereto. For example, based on identifying that no value is assigned to the keyword for the story topic, the at least one processor 207 may generate the media collection 820 by using the predetermined value for the keyword for the story topic, or may generate the media collection 820 by using a keyword different from the keyword for the story topic. For example, the operation of generating the media collection 820 by using the predetermined value and the operation of generating the media collection 820 by using the different keyword may be performed randomly. For example, based on identifying that no value is assigned to the keyword for the story topic, the at least one processor 207 may randomly identify the second keyword among remaining keywords for keywords 412-1, 412-2, . . . , 412-N corresponding to the at least one value indicating the user input 405, in order to identify media contents to be included in the media collection 820. For example, the operation of identifying the second keyword may be referred to as the operation 710 of FIG. 7.

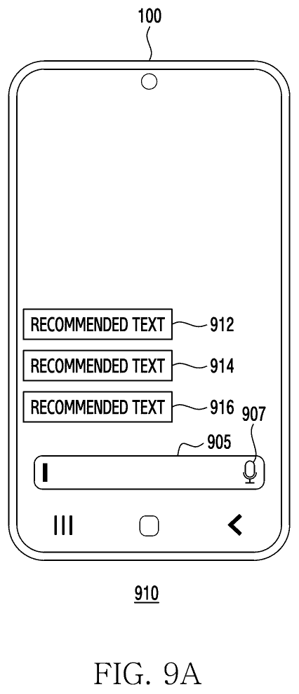

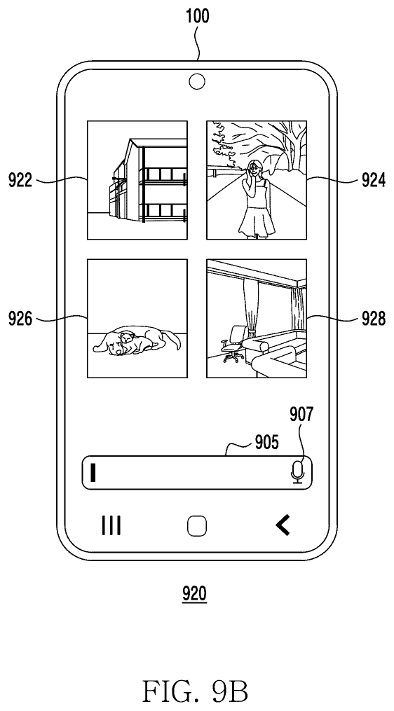

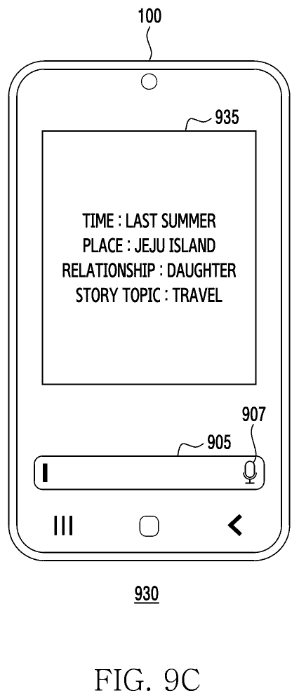

According to an embodiment, the electronic device 100 may include a display (not illustrated). For example, the electronic device 100 may receive the user input 405 via the display. For example, the electronic device 100 may display, via the display, a user interface (UI) for receiving the user input 405. For example, the electronic device 100 may display, via the display, visual objects (e.g., visual objects 912, 914, and 916 of FIG. 9A) for receiving the user input 405. For example, the visual objects for receiving the user input 405 will be described below with reference to FIGS. 9A to 9C.

FIG. 8 illustrates an operation of an electronic device for generating a media collection by arranging one or more second media contents according to an embodiment of the disclosure.

Referring to FIG. 8, at least one processor 207 may generate a media collection 820 by using one or more second media contents 810 and filtering information 410. For example, the at least one processor 207 may identify whether an arrangement order for the one or more second media contents 810 is indicated by a user input 405, by using the filtering information 410. For example, based on identifying the arrangement order for the one or more second media contents 810 by using the filtering information 410, the at least one processor 207 may generate the media collection 820 in which the one or more second media contents 810 are arranged according to the arrangement order. For example, the at least one processor 207 may identify a value for a keyword (e.g., an arrangement order of media contents) indicating an order of media contents, by using the filtering information 410. For example, the at least one processor 207 may generate the media collection 820 in which the one or more second media contents 810 are arranged based on the identified value. For example, the at least one processor 207 may determine an order for arranging media contents to be included the in the media collection 820 based on the user input 405. For example, the at least one processor 207 may generate the media collection 820 including the media contents arranged based on the order, by using first media contents 430 and the one or more second media contents 810.

According to an embodiment, the at least one processor 207 may not identify a method for arranging the one or more second media contents 810 by using the filtering information 410. For example, a value indicating the method for arranging the one or more second media contents 810 may not be indicated by the user input 405 (or the filtering information 410). For example, when the method is not identified, the at least one processor 207 may arrange the one or more second media contents 810 according to a preset order. For example, the preset order may include an order according to time at which a media content was obtained, an order according to a flow of time identified in a media content (e.g., an order of morning, afternoon, and evening), an order according to seasonal changes (e.g., an order of spring, summer, fall, and winter), an order according to an age of a person identified in media contents, an order according to user preference, and an order according to keywords.

According to an embodiment, when obtaining the user input 405 based on natural language, the at least one processor 207 may arrange the one or more second media contents 810 according to an order in which words identified via the user input 405 were obtained. For example, when obtaining the user input 405, the at least one processor 207 may sequentially identify or obtain a first word and a second word. For example, when generating a media collection by using the one or more second media contents 810 associated with the first word and the second word, the at least one processor 207 may generate or obtain a media collection in which at least one media content associated with the first word and at least one media content associated with the second word are sequentially arranged.

FIGS. 9A to 9C illustrate an operation of an electronic device for displaying a user interface (UI) for receiving a user input according to various embodiments of the disclosure.

Referring to FIG. 9A, a state 910 may be described as a state in which visual objects 912, 914, and 916 for receiving a user input 405 are displayed. For example, an electronic device 100 may include the display. For example, at least one processor 207 may display the visual objects 912, 914, and 916 for receiving the user input 405 via the display. For example, the visual objects 912, 914, and 916 may indicate a set of recommended text. For example, the at least one processor 207 may generate the recommended text by analyzing media contents 420 stored in memory 206. For example, the at least one processor 207 may identify a distribution for keywords and a distribution for values corresponding to the keywords by using filtering information 410. For example, the at least one processor 207 may obtain, identify, or generate the recommended text by using the distribution for the keywords and the distribution for the values. For example, based on receiving a user input for at least one of the visual objects 912, 914, and 916, the at least one processor 207 may generate a media collection 820 corresponding to the at least one.

According to an embodiment, the at least one processor 207 may receive the user input 405 indicating text. For example, the at least one processor 207 may display, via the display, a UI object 905 for receiving a user input indicating text based on natural language. For example, based on receiving the user input indicating the text based on natural language, the at least one processor 207 may display the text on the UI object 905. For example, the at least one processor 207 may generate the media collection 820 corresponding to the text based on receiving the user input.

According to an embodiment, the electronic device 100 may include the microphone. For example, the at least one processor 207 may obtain audio via the microphone. For example, the at least one processor 207 may receive a user input indicating the audio. For example, the at least one processor 207 may receive the user input indicating the audio based on receiving a user input for a visual object 907. For example, the at least one processor 207 may obtain text corresponding to the audio by performing speech recognition on the audio indicated by the user input. For example, the at least one processor 207 may perform a speech-to-text (STT) on the audio. For example, the at least one processor 207 may obtain the filtering information 410 based on the text corresponding to the audio. For example, the at least one processor 207 may generate the media collection 820 corresponding to the audio.

Referring to FIG. 9B, a state 920 may be described as a state in which visual objects 922, 924, 926, and 928 for receiving the user input 405 are displayed. For example, the at least one processor 207 may display the visual objects 922, 924, 926, and 928 via the display. For example, the visual objects 922, 924, 926, and 928 may correspond to each of recommended images. For example, the at least one processor 207 may identify or obtain a distribution for keywords and a distribution for values identified in the keywords by analyzing the filtering information 410 obtained based on the user input 405. For example, the at least one processor 207 may identify or determine a recommended image among the media contents 420 by using the distribution for the keywords and the distribution for the values. For example, the at least one processor 207 may generate the media collection 820 by using the identified recommended image.

According to an embodiment, the at least one processor 207 may receive the user input 405 indicating at least one of the media contents 420 stored in the memory 206. For example, the at least one processor 207 may generate the media collection 820 based on generating the filtering information 410 using the at least one.

According to an embodiment, the electronic device 100 may include a Video See-Through (VST) device. For example, the VST device may include a first camera (not illustrated) for obtaining images of a surrounding environment of the VST device, and a second camera (not illustrated) for obtaining images of a face (or a facial expression) of a user of the VST device. For example, the VST device may include a display (not illustrated). For example, the VST device may generate the media collection 820 by using a screen displayed via the display. For example, the screen may indicate images obtained via the first camera. For example, the VST device may generate the media collection 820 by obtaining the filtering information 410 based on the user input 405 indicating the screen. For example, the VST device may generate the media collection 820 by obtaining the filtering information 410 based on the user input 405 indicating the images obtained via the second camera.

Referring to FIG. 9C, a state 930 may be described as a state in which a visual object 935 indicating text data based on the user input 405 is displayed. For example, based on receiving the user input 405, the at least one processor 207 may display, via the display, the visual object 935 indicating text data 620 obtained based on the user input 405. For example, the at least one processor 207 may display the visual object 935, via the display, based on receiving the user input 405 indicating natural language such as “I want to create a story about traveling to Jeju Island with my daughter last summer.”. For example, the at least one processor 207 may provide feedback for generating a media collection to a user of the electronic device 100 by displaying the visual object 935. For example, via the visual object 935, the user may understand a method in which the generated media collection 820 is identified in the electronic device 100.

FIG. 10 is a block diagram illustrating an electronic device in a network environment according to various embodiments.

Referring to FIG. 10, an electronic device 1001 in a network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034. The non-volatile memory may include internal memory 1036 or external memory 1038.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter-wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002 or 1004, or the server 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

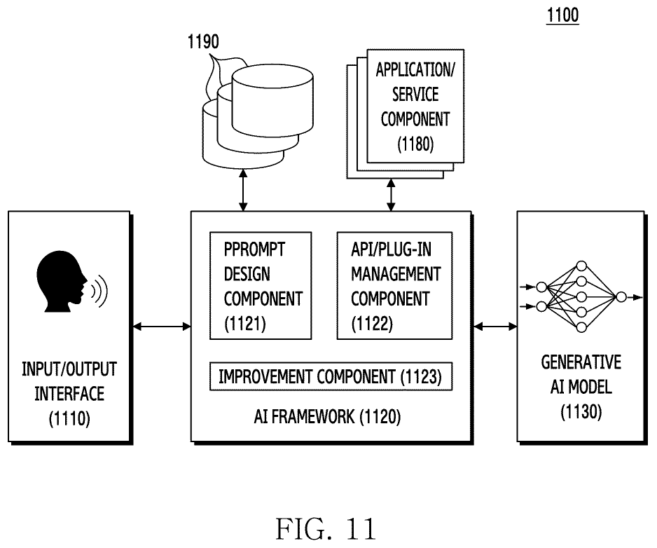

Some of the operations described above may be executed (or performed) through an artificial intelligence (AI) system described with reference to FIG. 11.

FIG. 11 is a schematic diagram of an exemplary artificial intelligence (AI) system.

Referring to FIG. 11, an AI system 1100 may include an input/output interface 1110, an AI framework 1120, a generative AI model 1130, and/or a knowledge repository 1190.

The input/output interface 1110 may receive an input. The input may include data obtained or generated by a user input and/or an electronic device (e.g., the electronic device 100 or the electronic device 1001 described above). The data may include an image, a video, and/or sensor data (e.g., illuminance data around the electronic device, posture data (or orientation data) of the electronic device, a temperature inside the electronic device (e.g., a temperature of a display or a temperature of at least one processor 207), all of which are obtained from a sensor or a sensor hub (e.g., an auxiliary processor), size information of a display area of the display, and/or an image obtained via an image sensor (e.g., included in a camera module 1080) of the electronic device) generated by at least one processor (e.g., the at least one processor 207 or a processor 1020) of the electronic device. The user input may include natural language, touch data obtained via touch circuitry (e.g., used to identify an input from a finger and/or a stylus) included in a display panel, an image and/or a video displayed (and/or to be displayed) on the display panel. As a non-limiting example, the user input may be received by the input/output interface 1110 with context information. The context information may be described as additional information obtained in association with the user input. The context information may be associated with a state (e.g., including a state of the electronic device and/or a state around the electronic device (e.g., a user state)) when the user input is received. For example, the context information may include information on one or more software applications executed in the electronic device when the user input is received. For example, the context information may include information on a location of the electronic device (or a location of a user of the electronic device) when the user input is received. For example, the user input may be integrated with the context information. For example, a user input in which the context information is integrated with the input may be received by the input/output interface 1110.

The input/output interface 1110 may transmit (or provide) an output. The output may include a result (or result information) generated or obtained by the AI system 1100, based at least in part on the input. A format of the output may vary. For example, the output may include natural language. For example, the output may include a content (e.g., including a media content and/or a multimedia content). For example, the output may include an action associated with the user of the electronic device. For example, the output may have a format according to a user setting of the electronic device.

The input/output interface 1110 may be described as a user query/response interface 1110.

The AI framework 1120 may be used to obtain information (or data) on the input from the input/output interface 1110, and to control one or more components associated with the AI system 1100 by using the obtained information.

For example, a prompt design component 1121 in the AI framework 1120 may generate or obtain a prompt for the generative AI model 1130 (e.g., including a large language model (LLM) or a large multimodal model (LMM)) by using the obtained information. For example, the prompt design component 1121 may be described as an AI component using a learning algorithm and/or a neural network to provide an enhanced prompt over time. For example, the prompt design component 1121 may generate or obtain the prompt by accessing a knowledge component (e.g., the knowledge repository 1190) including user preference data, a prompt library, and/or a prompt example by using the obtained information. The generated prompt may be provided to the generative AI model 1130 (e.g., including the LLM or the LMM).

For example, an API/plugin management component 1122 in the AI framework 1120 may be used to support communication for additional information requested (or caused) in association with the prompt provided (or to be provided) to the generative AI model 1130. For example, the API/plugin management component 1122 may be used to generate or establish a channel for communication with various data sources (e.g., the knowledge repository 1190). For example, the API/plugin management component 1122 may support access to at least a portion of the data sources. For example, the API/plugin management component 1122 may be used to request another component (e.g., an application/service component 1180) performing feedback (or a response) according to the prompt. As a non-limiting example, information obtained (or generated) via the API/plugin management component 1122 may be provided to the prompt design component 1121 for generating the prompt. As a non-limiting example, information obtained (or generated) via the API/plugin management component 1122 may be provided to the generative AI model 1130.

For example, an improvement component 1123 in the AI framework 1120 may at least partially tune (or adjust) (or change) a result (e.g., a content) obtained (or outputted) from the generative AI model 1130. For example, the improvement component 1123 may determine or verify whether the content obtained from the generative AI model 1130 is associated with the input. For example, the improvement component 1123 may determine or verify whether the content obtained from the generative AI model 1130 includes biased content. For example, the improvement component 1123 may determine or verify whether the content obtained from the generative AI model 1130 includes harmful content. For example, the improvement component 1123 may support or assist in performing additional processing to improve the content obtained from the generative AI model 1130. For example, the improvement component 1123 may support providing a hint to a user to improve the content.

The generative AI model 1130 may be described as an artificial intelligence neural network that generates feedback in response to a prompt. For example, the feedback is associated with the prompt, but may further include additional data and/or information relative to the prompt. For example, the feedback may include a new content relative to the prompt. For example, the generative AI model 1130 may include a model that generates an image, and/or a model that generates language. For example, the model that generates an image may include a generative adversarial network (GAN) and/or a variational auto encoder (VAE). For example, the model that generates an image may include a diffusion-based generative model (e.g., a transformer VAE). For example, the model that generates language may include CHAT-GPT 3 and/or CHAT-GPT 4. For example, the generative AI model 1130 may include an LMM that generates the feedback by recognizing text, an image, and/or a speech.

As a non-limiting example, the AI framework 1120 and/or the generative AI model 1130 may be included in an AI module (e.g., including processing circuitry) in the electronic device. For example, the AI module may be operably coupled to at least one processor (e.g., the at least one processor 207 or the processor 1020) of the electronic device. For example, the AI module may be operably coupled to display driving circuitry (e.g., display driving circuitry or DDI) of the electronic device. For example, the AI module may be operably coupled to the sensor hub of the electronic device for one or more sensors in the electronic device.

The technical problems to be achieved in the disclosure are not limited to those described above, and other technical problems not mentioned herein will be clearly understood by those having ordinary knowledge in the art to which the disclosure belongs.

As described above, an electronic device (e.g., the electronic device 100) may comprise memory (e.g., the memory 206) storing instructions. The electronic device may comprise at least one processor (e.g., the at least one processor 207). The instructions, when executed by the at least one processor individually or collectively, may cause the electronic device to receive a user input to generate a media collection including media contents. The instructions, when executed by the at least one processor individually or collectively, may cause the electronic device to identify, among media contents stored in the memory, first media contents corresponding to a first keyword included in the user input. The instructions, when executed by the at least one processor individually or collectively, may cause the electronic device to identify, based on identifying the number of the first media contents less than a reference number, among keywords assigned to the first media contents, a second keyword. The instructions, when executed by the at least one processor individually or collectively, may cause the electronic device to identify one or more second media contents corresponding to the second keyword. The instructions, when executed by the at least one processor individually or collectively, may cause the electronic device to generate the media collection by using the first media contents and the one or more second media contents.

According to an embodiment, the first keyword may correspond to a value indicating the user input. The second keyword may be included in remaining keywords for the first keyword among the assigned keywords to indicate a media content. The instructions, when executed by the at least one processor individually or collectively, may cause the electronic device to identify, based on identifying the second keyword, the number of the one or more second media contents associated with a value corresponding to the second keyword. The instructions, when executed by the at least one processor individually or collectively, may cause the electronic device to generate, based on determination that the number of the one or more second media contents is within a reference range, the media collection including the one or more second media contents.

According to an embodiment, the instructions, when executed by the at least one processor individually or collectively, may cause the electronic device to identify, based on determination that the number of the one or more second media contents is out of the reference range, among the remaining keywords, a third keyword. The instructions, when executed by the at least one processor individually or collectively, may cause the electronic device to identify, based on identifying the third keyword, the number of one or more third media contents associated with another value corresponding to the third keyword. The instructions, when executed by the at least one processor individually or collectively, may cause the electronic device to generate, based on determination that the number of the one or more third media contents is within the reference range, the media collection including the one or more third media contents.

According to an embodiment, the instructions, when executed by the at least one processor individually or collectively, may cause the electronic device to obtain, based on the user input, filtering information, which is to identify the first media contents, indicating at least one value corresponding to at least one keyword among the assigned keywords to indicate a media content. The instructions, when executed by the at least one processor individually or collectively, may cause the electronic device to identify, by using the filtering information, among the assigned keywords, the first keyword corresponding to the user input.

According to an embodiment, the filtering information may be obtained by combining first text data obtained via the user input indicating text based on natural language, and second text data obtained via another user input indicating other text based on natural language.

According to an embodiment, the instructions, when executed by the at least one processor individually or collectively, may cause the electronic device to obtain, by using the user input indicating text based on natural language, text data indicating text corresponding to the at least one keyword among the assigned keywords. The instructions, when executed by the at least one processor individually or collectively, may cause the electronic device to obtain, by using the text data, the filtering information to search a database for media contents.

According to an embodiment, the text data may be obtained via a language model trained to output at least one word corresponding to at least one among the assigned keywords using text.

According to an embodiment, the instructions, when executed by the at least one processor individually or collectively, may cause the electronic device to obtain, based on the user input indicating an image, a first embedding vector indicating a first value corresponding to the first keyword. The instructions, when executed by the at least one processor individually or collectively, may cause the electronic device to obtain similarities between second embedding vectors, which respectively indicate second values corresponding to the first keyword, respectively corresponding to media contents stored in the memory, and the first embedding vector. The instructions, when executed by the at least one processor individually or collectively, may cause the electronic device to determine, as the first media contents, media contents corresponding to a similarity higher than a threshold similarity among the similarities.

According to an embodiment, the instructions, when executed by the at least one processor individually or collectively, may cause the electronic device to determine, based on the user input, an order to arrange media contents to be included in the media collection. The instructions, when executed by the at least one processor individually or collectively, may cause the electronic device to generate, by using the first media contents and the one or more second media contents, the media collection including the media contents arranged based on the order.

According to an embodiment, the user input may indicate at least a portion among text, an image, a video, or audio.

According to an embodiment, the instructions, when executed by the at least one processor individually or collectively, may cause the electronic device to identify, among media contents stored in the memory, third media contents corresponding to a first value and a second value for the first keyword. The instructions, when executed by the at least one processor individually or collectively, may cause the electronic device to identify, based on identifying the number of the third media contents less than another reference number, among media contents stored in the memory, fourth media contents corresponding to the first value or the second value. The instructions, when executed by the at least one processor individually or collectively, may cause the electronic device to determine, based on identifying the number of the fourth media contents greater than the other reference number and less than the reference number, as the first media contents, the fourth media contents.

As described above, a method performed by an electronic device (e.g., the electronic device 100) with memory (e.g., the memory 206), may comprise receiving a user input to generate a media collection including media contents. The method may comprise identifying, among media contents stored in the memory, first media contents corresponding to a first keyword included in the user input. The method may comprise identifying, based on identifying the number of the first media contents less than a reference number, among keywords assigned to the first media contents, a second keyword. The method may comprise identifying one or more second media contents corresponding to the second keyword. The method may comprise generating the media collection by using the first media contents and the one or more second media contents.

According to an embodiment, the first keyword may correspond to a value indicating the user input. The second keyword may be included in remaining keywords for the first keyword among the assigned keywords to indicate a media content. The method may comprise identifying, based on identifying the second keyword, the number of the one or more second media contents associated with a value corresponding to the second keyword. The method may comprise generating, based on determination that the number of the one or more second media contents is within a reference range, the media collection including the one or more second media contents.

According to an embodiment, the method may comprise identifying, based on determination that the number of the one or more second media contents is out of the reference range, among the remaining keywords, a third keyword. The method may comprise identifying, based on identifying the third keyword, the number of one or more third media contents associated with another value corresponding to the third keyword. The method may comprise generating, based on determination that the number of the one or more third media contents is within the reference range, the media collection including the one or more third media contents.

According to an embodiment, the method may comprise obtaining, based on the user input, filtering information, which is to identify the first media contents, indicating at least one value corresponding to at least one keyword among the assigned keywords to indicate a media content. The method may comprise identifying, by using the filtering information, among the assigned keywords, the first keyword corresponding to the user input.

According to an embodiment, the filtering information may be obtained by combining first text data obtained via the user input indicating text based on natural language, and second text data obtained via another user input indicating other text based on natural language.

According to an embodiment, the method may comprise obtaining, by using the user input indicating text based on natural language, text data indicating text corresponding to the at least one keyword among the assigned keywords. The method may comprise obtaining, by using the text data, the filtering information to search a database for media contents.

According to an embodiment, the text data may be obtained via a language model trained to output at least one word corresponding to at least one among the assigned keywords using text.

According to an embodiment, the method may comprise obtaining, based on the user input indicating an image, a first embedding vector indicating a first value corresponding to the first keyword. The method may comprise obtaining similarities between second embedding vectors, which respectively indicate second values corresponding to the first keyword, respectively corresponding to media contents stored in the memory, and the first embedding vector. The method may comprise determining, as the first media contents, media contents corresponding to a similarity higher than a threshold similarity among the similarities.

According to an embodiment, the method may comprise determining, based on the user input, an order to arrange media contents to be included in the media collection. The method may comprise generating, by using the first media contents and the one or more second media contents, the media collection including the media contents arranged based on the order.

According to an embodiment, the user input may indicate at least a portion among text, an image, a video, or audio.

According to an embodiment, the method may comprise identifying, among media contents stored in the memory, third media contents corresponding to a first value and a second value for the first keyword. The method may comprise identifying, based on identifying the number of the third media contents less than another reference number, among media contents stored in the memory, fourth media contents corresponding to the first value or the second value. The method may comprise determining, based on identifying the number of the fourth media contents greater than the other reference number and less than the reference number, as the first media contents, the fourth media contents.

As described above, in a computer readable storage medium storing one or more programs, the one or more programs may comprise instructions to, when executed by an electronic device (e.g., the electronic device 100) with memory (e.g., the memory 206), cause the electronic device to receive a user input to generate a media collection including media contents. The one or more programs may comprise instructions to, when executed by the electronic device, cause the electronic device to identify, among media contents stored in the memory, first media contents corresponding to a first keyword included in the user input. The one or more programs may comprise instructions to, when executed by the electronic device, cause the electronic device to identify, based on identifying the number of the first media contents less than a reference number, among keywords assigned to the first media contents, a second keyword. The one or more programs may comprise instructions to, when executed by the electronic device, cause the electronic device to identify one or more second media contents corresponding to the second keyword. The one or more programs may comprise instructions to, when executed by the electronic device, cause the electronic device to generate the media collection by using the first media contents and the one or more second media contents.

According to an embodiment, the first keyword may correspond to a value indicating the user input. The second keyword may be included in remaining keywords for the first keyword among the assigned keywords to indicate a media content. The one or more programs may comprise instructions to, when executed by the electronic device, cause the electronic device to identify, based on identifying the second keyword, the number of the one or more second media contents associated with a value corresponding to the second keyword. The one or more programs may comprise instructions to, when executed by the electronic device, cause the electronic device to generate, based on determination that the number of the one or more second media contents is within a reference range, the media collection including the one or more second media contents.

According to an embodiment, the one or more programs may comprise instructions to, when executed by the electronic device, cause the electronic device to identify, based on determination that the number of the one or more second media contents is out of the reference range, among the remaining keywords, a third keyword. The one or more programs may comprise instructions to, when executed by the electronic device, cause the electronic device to identify, based on identifying the third keyword, the number of one or more third media contents associated with another value corresponding to the third keyword. The one or more programs may comprise instructions to, when executed by the electronic device, cause the electronic device to generate, based on determination that the number of the one or more third media contents is within the reference range, the media collection including the one or more third media contents.

According to an embodiment, the one or more programs may comprise instructions to, when executed by the electronic device, cause the electronic device to obtain, based on the user input, filtering information, which is to identify the first media contents, indicating at least one value corresponding to at least one keyword among the assigned keywords to indicate a media content. The one or more programs may comprise instructions to, when executed by the electronic device, cause the electronic device to identify, by using the filtering information, among the assigned keywords, the first keyword corresponding to the user input.

According to an embodiment, the filtering information may be obtained by combining first text data obtained via the user input indicating text based on natural language, and second text data obtained via another user input indicating other text based on natural language.

According to an embodiment, the one or more programs may comprise instructions to, when executed by the electronic device, cause the electronic device to obtain, by using the user input indicating text based on natural language, text data indicating text corresponding to the at least one keyword among the assigned keywords. The one or more programs may comprise instructions to, when executed by the electronic device, cause the electronic device to obtain, by using the text data, the filtering information to search a database for media contents.

According to an embodiment, the text data may be obtained via a language model trained to output at least one word corresponding to at least one among the assigned keywords using text.

According to an embodiment, the one or more programs may comprise instructions to, when executed by the electronic device, cause the electronic device to obtain, based on the user input indicating an image, a first embedding vector indicating a first value corresponding to the first keyword. The one or more programs may comprise instructions to, when executed by the electronic device, cause the electronic device to obtain similarities between second embedding vectors, which respectively indicate second values corresponding to the first keyword, respectively corresponding to media contents stored in the memory, and the first embedding vector. The one or more programs may comprise instructions to, when executed by the electronic device, cause the electronic device to determine, as the first media contents, media contents corresponding to a similarity higher than a threshold similarity among the similarities.

According to an embodiment, the one or more programs may comprise instructions to, when executed by the electronic device, cause the electronic device to determine, based on the user input, an order to arrange media contents to be included in the media collection. The one or more programs may comprise instructions to, when executed by the electronic device, cause the electronic device to generate, by using the first media contents and the one or more second media contents, the media collection including the media contents arranged based on the order.

According to an embodiment, the user input may indicate at least a portion among text, an image, a video, or audio.

According to an embodiment, the one or more programs may comprise instructions to, when executed by the electronic device, cause the electronic device to identify, among media contents stored in the memory, third media contents corresponding to a first value and a second value for the first keyword. The one or more programs may comprise instructions to, when executed by the electronic device, cause the electronic device to identify, based on identifying the number of the third media contents less than another reference number, among media contents stored in the memory, fourth media contents corresponding to the first value or the second value. The one or more programs may comprise instructions to, when executed by the electronic device, cause the electronic device to determine, based on identifying the number of the fourth media contents greater than the other reference number and less than the reference number, as the first media contents, the fourth media contents.

The effects that may be obtained from the disclosure are not limited to those described above, and any other effects not mentioned herein will be clearly understood by those having ordinary knowledge in the art to which the disclosure belongs.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a compact disc (CD)-ROM and digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory comprising one or more storage media storing instructions; and
at least one processor comprising processing circuitry,
wherein the instructions, when executed by the at least one processor individually or collectively, cause the electronic device to:
receive a user input to generate a media collection including media contents,
identify, among media contents stored in the memory, first media contents corresponding to a first keyword included in the user input,
based on identifying the number of the first media contents less than a reference number, identify, among keywords assigned to the first media contents, a second keyword,
identify one or more second media contents corresponding to the second keyword, and
by using the first media contents and the one or more second media contents, generate the media collection.

2. The electronic device of claim 1,
wherein the first keyword corresponds to a value indicating the user input,
wherein the second keyword is included in remaining keywords for the first keyword among the assigned keywords to indicate a media content, and
wherein the instructions, when executed by the at least one processor individually or collectively, cause the electronic device to:
based on identifying the second keyword, identify the number of the one or more second media contents associated with a value corresponding to the second keyword, and
based on determination that the number of the one or more second media contents is within a reference range, generate the media collection including the one or more second media contents.

3. The electronic device of claim 2, wherein the instructions, when executed by the at least one processor individually or collectively, cause the electronic device to:
based on determination that the number of the one or more second media contents is out of the reference range, identify, among the remaining keywords, a third keyword,
based on identifying the third keyword, identify the number of one or more third media contents associated with another value corresponding to the third keyword, and
based on determination that the number of the one or more third media contents is within the reference range, generate the media collection including the one or more third media contents.

4. The electronic device of claim 1, wherein the instructions, when executed by the at least one processor individually or collectively, cause the electronic device to:
based on the user input, obtain filtering information, which is to identify the first media contents, indicating at least one value corresponding to at least one keyword among the assigned keywords to indicate a media content, and
by using the filtering information, identify, among the assigned keywords, the first keyword corresponding to the user input.

5. The electronic device of claim 4, wherein the filtering information is obtained by combining first text data obtained via the user input indicating text based on natural language, and second text data obtained via another user input indicating other text based on natural language.

6. The electronic device of claim 4, wherein the instructions, when executed by the at least one processor individually or collectively, cause the electronic device to:
by using the user input indicating text based on natural language, obtain text data indicating text corresponding to the at least one keyword among the assigned keywords, and
by using the text data, obtain the filtering information to search a database for media contents.

7. The electronic device of claim 6, wherein the text data is obtained via a language model trained to output at least one word corresponding to at least one among the assigned keywords using text.

8. The electronic device of claim 1, wherein the instructions, when executed by the at least one processor individually or collectively, cause the electronic device to:
based on the user input indicating an image, obtain a first embedding vector indicating a first value corresponding to the first keyword,
obtain similarities between second embedding vectors, which respectively indicate second values corresponding to the first keyword, respectively corresponding to media contents stored in the memory, and the first embedding vector, and
determine, as the first media contents, media contents corresponding to a similarity higher than a threshold similarity among the similarities.

9. The electronic device of claim 1, wherein the instructions, when executed by the at least one processor individually or collectively, cause the electronic device to:
based on the user input, determine an order to arrange media contents to be included in the media collection, and
by using the first media contents and the one or more second media contents, generate the media collection including the media contents arranged based on the order.

10. The electronic device of claim 1, wherein the user input indicates at least a portion among text, an image, a video, or audio.

11. The electronic device of claim 1, wherein the instructions, when executed by the at least one processor individually or collectively, cause the electronic device to:
based on the user input, identify, among media contents stored in the memory, third media contents corresponding to a first value and a second value for the first keyword,
based on identifying the number of the third media contents less than another reference number, identify, among media contents stored in the memory, fourth media contents corresponding to the first value or the second value, and
based on identifying the number of the fourth media contents greater than the other reference number and less than the reference number, determine, as the first media contents, the fourth media contents.

12. A non-transitory computer readable storage medium storing one or more programs, the one or more programs comprising instructions to, when executed by an electronic device with memory, cause the electronic device to:
receive a user input to generate a media collection including media contents,
identify, among media contents stored in the memory, first media contents corresponding to a first keyword included in the user input,
based on identifying the number of the first media contents less than a reference number, identify, among keywords assigned to the first media contents, a second keyword,
identify one or more second media contents corresponding to the second keyword, and
by using the first media contents and the one or more second media contents, generate the media collection.

13. The non-transitory computer readable storage medium of claim 12,
wherein the first keyword corresponds to a value indicating the user input,
wherein the second keyword is included in remaining keywords for the first keyword among the assigned keywords to indicate a media content, and
wherein the one or more programs comprise instructions to, when executed by the electronic device, cause the electronic device to:
based on identifying the second keyword, identify the number of the one or more second media contents associated with a value corresponding to the second keyword, and
based on determination that the number of the one or more second media contents is within a reference range, generate the media collection including the one or more second media contents.

14. The non-transitory computer readable storage medium of claim 13, wherein the one or more programs comprise instructions to, when executed by the electronic device, cause the electronic device to:
based on determination that the number of the one or more second media contents is out of the reference range, identify, among the remaining keywords, a third keyword,
based on identifying the third keyword, identify the number of one or more third media contents associated with another value corresponding to the third keyword, and
based on determination that the number of the one or more third media contents is within the reference range, generate the media collection including the one or more third media contents.

15. The non-transitory computer readable storage medium of claim 12, wherein the one or more programs comprise instructions to, when executed by the electronic device, cause the electronic device to:
based on the user input, obtain filtering information, which is to identify the first media contents, indicating at least one value corresponding to at least one keyword among the assigned keywords to indicate a media content, and
by using the filtering information, identify, among the assigned keywords, the first keyword corresponding to the user input.

16. The non-transitory computer readable storage medium of claim 15, wherein the filtering information is obtained by combining first text data obtained via the user input indicating text based on natural language, and second text data obtained via another user input indicating other text based on natural language.

17. The non-transitory computer readable storage medium of claim 15, wherein the one or more programs comprise instructions to, when executed by the electronic device, cause the electronic device to:
by using the user input indicating text based on natural language, obtain text data indicating text corresponding to the at least one keyword among the assigned keywords, and
by using the text data, obtain the filtering information to search a database for media contents.

18. A method executed in an electronic device with memory, the method comprising:
receiving a user input to generate a media collection including media contents,
identifying, among media contents stored in the memory, first media contents corresponding to a first keyword included in the user input,
based on identifying the number of the first media contents less than a reference number, identifying, among keywords assigned to the first media contents, a second keyword,
identifying one or more second media contents corresponding to the second keyword, and
by using the first media contents and the one or more second media contents, generating the media collection.

19. The method of claim 18, further comprising:
determining an order for arranging media contents to be included in the media collection based on the user input.

20. The method of claim 19, wherein the media collection includes the media contents arranged based on the order, by using first media contents and the one or more second media contents.
